(19) United States
(12) Patent Application Publication
(10) Pub. No.: US 2026/0367290 A1
(43) Pub. Date: Nov. 19, 2026

(54) OPTICAL ELEMENT

(71) Applicant: Samsung Electro-Mechanics Co., Ltd., Suwon-si (KR)

(72) Inventors: Jae Hwa SHIM, Suwon-si (KR); Yong Joo JO, Suwon-si (KR); Sang Beom SEO, Suwon-si (KR); Dong Hyun LEE, Suwon-si (KR); Bong Ju KIM, Suwon-si (KR)

(73) Assignee: Samsung Electro-Mechanics Co., Ltd., Suwon-si (KR)

(21) Appl. No.: 19/654,194

(22) Filed: Apr. 21, 2026

(30) Foreign Application Priority Data
May 19, 2025 (KR) 10-2025-0064629
Jan. 12, 2026 (KR) 10-2026-0005588

(51) Int. Cl. G02B 3/04

(52) U.S. Cl. CPC G02B 3/04

(57) ABSTRACT

An optical element includes a first optical member having refractive power and made of a glass material, a second optical member disposed on a first surface of the first optical member and made of a plastic material, and a first coating member disposed between the first optical member and the second optical member. The first surface includes a first region having a first roughness and a second region having a second roughness.

### CROSS-REFERENCE TO RELATED APPLICATIONS

This application claims the benefit under 35 USC 119(a) of Korean Patent Application Nos. 10-2025-0064629 filed on May 19, 2025, and 10-2026-0005588 filed on Jan. 12, 2026, in the Korean Intellectual Property Office, the entire disclosures of which are incorporated herein by reference for all purposes.

### BACKGROUND

### 1. Field

The present disclosure relates to an optical element including an aspherical shape.

### 2. Description of the Background

Camera modules may include one or more lenses having refractive power. For example, camera modules may include lenses having positive or negative refractive power. Since a lens having refractive power has at least one convex or concave surface, spherical aberration may be induced. To resolve this problem, methods of forming one surface of a glass lens as an aspherical shape or using an aspherical plastic lens have been used. However, the lens of the former case may have a disadvantage of being difficult to process and expensive, while the lens of the latter case may have a disadvantage of having lower optical performance compared to the shape of the former case.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an optical element includes a first optical member having refractive power and made of a glass material, a second optical member disposed on a first surface of the first optical member and made of a plastic material, and a first coating member disposed between the first optical member and the second optical member. The first surface includes a first region having a first roughness and a second region having a second roughness.

The first surface may have a spherical shape.

The second optical member may include an aspherical shape.

The first region may be disposed around an optical axis of the first surface, and the second region may be disposed at an edge of the first region.

The first roughness may be less than the second roughness.

The first surface may have a convex or concave shape.

The optical element may further include a third optical member disposed on a second surface of the first optical member.

In another general aspect, an optical element includes a first optical member including an incident surface, a reflective surface, and an exit surface and made of a glass material, a second optical member disposed on a first surface of the first optical member and made of a plastic material, and a first coating member disposed between the first optical member and the second optical member, wherein the first surface includes a first region having a first roughness and a second region having a second roughness.

The second optical member may have a shape including an aspherical surface.

The second optical member may have a shape having refractive power.

The first optical member may have a shape having refractive power.

One or more of the incident surface and the exit surface may have a convex or concave shape.

One or more of the incident surface and the exit surface may have a spherical shape.

The second optical member may have an aspherical shape.

Other features and aspects will be apparent from the following detailed description, the drawings, and the claims.

### BRIEF DESCRIPTION OF DRAWINGS

FIG. 1 is a cross-sectional view of an optical element according to a first embodiment.

FIG. 2 is an enlarged view of portion A illustrated in FIG. 1.

FIG. 3 is a cross-sectional view of an optical element according to a second embodiment.

FIG. 4 is an enlarged view of portion B illustrated in FIG. 3.

FIG. 5 is a cross-sectional view of an optical element according to a third embodiment.

FIG. 6 is an enlarged view of portion D illustrated in FIG. 5.

FIG. 7 is a cross-sectional view of an optical element according to a fourth embodiment.

FIG. 8 is an enlarged view of portion E illustrated in FIG. 7.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being "on," "connected to," or "coupled to" another element, it may be directly "on," "connected to," or "coupled to" the other element, or there may be one or more other elements intervening therebetween. In contrast, when an element is described as being "directly on," "directly connected to," or "directly coupled to" another element, there can be no other elements intervening therebetween.

As used herein, the term "and/or" includes any one and any combination of any two or more of the associated listed items; likewise, "at least one of" includes any one and any combination of any two or more of the associated listed items.

Although terms such as "first," "second," and "third" may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as "above," "upper," "below," "lower," and the like, may be used herein for ease of description to describe one element’s relationship to another element as shown in the figures. Such spatially relative terms are intended to encompass different orientations of the device in use or operation in addition to the orientation depicted in the figures. For example, if the device in the figures is turned over, an element described as being "above," or "upper" relative to another element would then be "below," or "lower" relative to the other element. Thus, the term "above" encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles "a," "an," and "the" are intended to include the plural forms as well, unless the context clearly indicates otherwise. The terms "comprises," "includes," and "has" specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term "may" with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

An aspect of the present disclosure is to provide an optical element that is easy to manufacture, while including both optical characteristics of glass material and aspherical characteristics.

An optical element according to a first embodiment of the present disclosure may include optical members of different materials. For example, the optical element according to the present embodiment may include a first optical member made of a glass material and a second optical member disposed on a first surface of the first optical member and made of a plastic material. The optical element according to the present embodiment may have refractive power. For example, in the optical element according to the present embodiment, the first optical member may be configured in the form of a lens having refractive power. The optical element according to the present embodiment may further include a component for improving optical performance. For example, the optical element according to the present embodiment may include a first coating member disposed between the first optical member and the second optical member. The optical element according to the present embodiment may include a component for improving bonding strength between the first optical member and the second optical member. For example, in the optical element according to the present embodiment, the first surface may include a first region having first roughness and a second region having second roughness.

An optical element according to a second embodiment of the present disclosure may include optical members of different materials. For example, the optical element according to the present embodiment may include a first optical member made of a glass material and a second optical member made of a plastic material disposed on a first surface of the first optical member. The optical element according to the present embodiment may include a reflective surface. For example, in the optical element according to the present embodiment, the first optical member may be configured in the form of a prism including an incident surface, a reflective surface, and an exit surface. The optical element according to the present embodiment may further include a component for improving optical performance. For example, the optical element according to the present embodiment may include a first coating member disposed between the first optical member and the second optical member. The optical element according to the present embodiment may include a component for improving bonding strength between the first optical member and the second optical member. For example, in the optical element according to the present embodiment, a first surface may include a first region having first roughness and a second region having second roughness.

Next, an optical element according to an embodiment of the present disclosure will be described with reference to the drawings.

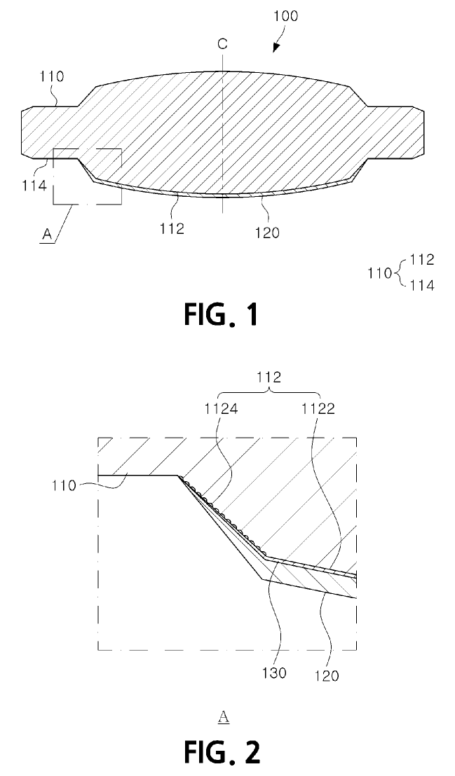

In the following, an optical element according to an embodiment of the present disclosure will be described. First, the optical element according to the first embodiment will be described with reference to FIGS. 1 and 2.

An optical element 100 according to the present embodiment may include two or more different materials. For example, the optical element 100 may include a first optical member 110 and a second optical member 120. However, the configuration of the optical element 100 is not limited to the first optical member 110 and the second optical member 120. For example, the optical element 100 may further include a third optical member, different from the first optical member 110 and the second optical member 120.

The first optical member 110 may be made of a material having excellent optical transparency and high rigidity. For example, the first optical member 110 may be made of a glass material with a high refractive index. The first optical member 110 may be configured to have refractive power. For example, the first optical member 110 may have a positive or negative refractive power. The first optical member 110 may include an optical portion 112 and a flange portion 114. However, the optical portion 112 and the flange portion 114 are not necessarily included in the first optical member 110. For example, the first optical member 110 may be configured without the flange portion 114 as needed.

The optical portion 112 may be disposed around (including) the optical axis C of the first optical member 110. For example, the optical portion 112 may be disposed in a circular shape around an optical axis C. The optical portion 112 may have refractive power. For example, the first surface (object-side surface) of the optical portion 112 may be convex or concave. As another example, the second surface (image-side surface) of the optical portion 112 may be convex or concave. The optical portion 112 may have a spherical surface. For example, at least one surface of the optical portion 112 may have a spherical surface to facilitate processing or manufacturing.

The flange portion 114 may be disposed to be adjacent to the optical portion 112. As a specific example, the flange portion 114 may be formed to a certain size along the edge of the optical portion 112. The flange portion 114 may be formed not to have refractive power. As an example, both the first surface and the second surface of the flange portion 114 may be flat so that incident light is not refracted. As another example, the flange portion 114 may be coated with a light-blocking material so that light transmission does not occur.

The second optical member 120 may be made of a different material from that of the first optical member 110. For example, the second optical member 120 may be made of a material, such as synthetic resin or plastic, that is easy to process. However, the material of the second optical member 120 is not limited to the aforementioned materials. The second optical member 120 may be disposed on at least one surface of the first optical member 110. The second optical member 120 may be formed directly on one surface of the first optical member 110. For example, the second optical member 120 in an uncured state may be cured or molded into a specific shape via the first optical member 110 and a molding mold. The second optical member 120 formed in this manner may be formed in close contact with one surface of the first optical member 110.

The second optical member 120 may be configured to have both a spherical surface and an aspherical surface. For example, the first surface of the second optical member 120 contacting the first optical member 110 may have a spherical surface, and the second surface not contacting the first optical member 110 may have an aspherical surface.

The optical element 100 according to the present embodiment may be configured to improve bonding strength between the first optical member 110 and the second optical member 120. For example, a portion of the first optical member 110 contacting the second optical member 120 may be configured to have different roughness.

The optical portion 112 of the first optical member 110 may include a first region 1122 and a second region 1124 as illustrated in FIG. 2. The first region 1122 is disposed around the optical axis C of the optical portion 112, and the second region 1124 may be disposed at the edge of the first region 1122 or at a portion in which the optical portion 112 is connected to the flange portion 114.

The first region 1122 and the second region 1124 may be configured to have different roughness from each other. For example, the first region 1122 may be configured to have roughness less than that of the second region 1124. As an example, the first region 1122 may have a roughness of a size having almost no effect on the refractive power of light. As a specific example, the first region 1122 may have a roughness ranging from 1.0 nm to 10 nm. As another example, the second region 1124 may have a roughness of a size that may improve bonding strength between the first optical member 110 and the second optical member 120. As a specific example, the second region 1124 may have a roughness of 1.0 µm to 20 µm. As another specific example, the second region 1124 may have a roughness of 0.20 µm to 4 µm.

The first region 1122 may be formed to be wider than the second region 1124. As an example, the second region 1124 may be formed to be limited to the edge of the first region 1122. As another example, the second region 1124 may be formed at a predetermined interval along the edge of the first region 1122.

The optical element 100 according to the present embodiment may further include a component capable of improving optical performance. For example, the optical element 100 may further include a coating member 130. The coating member 130 may be disposed between the first optical member 110 and the second optical member 120. For example, the coating member 130 may be disposed only in a region corresponding to the first region 1122 of the first optical member 110. The coating member 130 may be made of an inorganic material, such as TiO₂, SiO₂, or MgF₂, or may be made of a composite material including the aforementioned material. The coating member 130 configured in this manner may form an anti-reflective layer in the optical element 100 to suppress a flare phenomenon that may occur between the first optical member 110 and the second optical member 120.

The optical element 100 configured as described above has a high refractive index and an aspherical shape facilitating aberration improvement, so it may replace aspherical glass lenses, which are difficult to manufacture and have high manufacturing costs. Therefore, the optical element 100 according to the present embodiment may not only reduce the cost required to manufacture a high-resolution camera module but also improve the performance of the camera module.

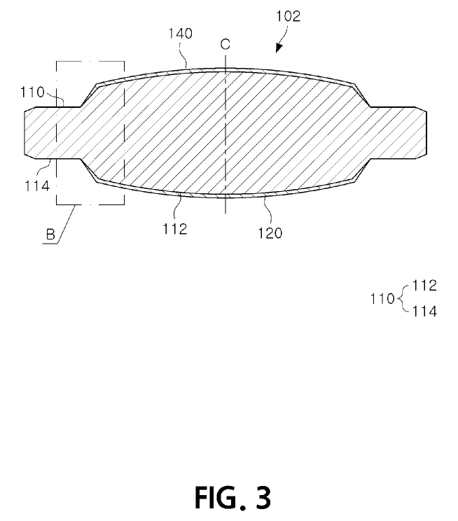

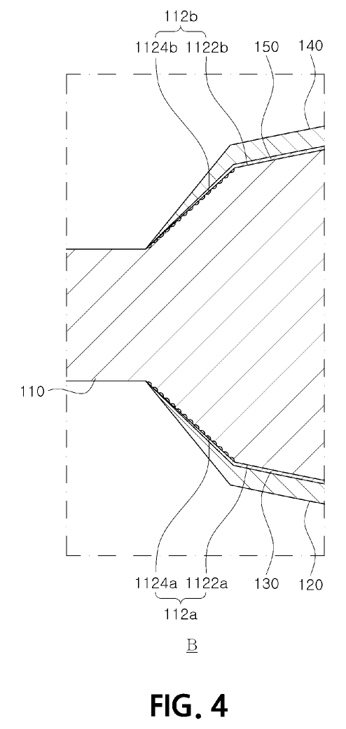

An optical element according to a second embodiment will be described with reference to FIGS. 3 and 4.

An optical element 102 according to the present embodiment may include two or more different materials. For example, the optical element 102 may include a first optical member 110, a second optical member 120, and a third optical member 140. However, the configuration of the optical element 102 is not limited to the first optical member 110, the second optical member 120, and the third optical member 140.

The first optical member 110 may be made of a material with excellent optical transparency and high rigidity. For example, the first optical member 110 may be made of a glass material with a high refractive index. The first optical member 110 may be configured to have refractive power. For example, the first optical member 110 may have positive or negative refractive power. The first optical member 110 may include an optical portion 112 and a flange portion 114. However, the optical portion 112 and the flange portion 114 are not necessarily included in the first optical member 110. For example, the first optical member 110 may be configured without the flange portion 114 as needed.

The optical portion 112 may be disposed around the optical axis C of the first optical member 110. For example, the optical portion 112 may have a circular shape around the optical axis C. The optical portion 112 may have refractive power. For example, the first surface (object-side surface) of the optical portion 112 may be convex or concave. For another example, the second surface (image-side surface) of the optical portion 112 may be convex or concave. The optical portion 112 may have a spherical surface. For example, at least one surface of the optical portion 112 may have a spherical surface to facilitate processing or manufacturing.

The flange portion 114 may be disposed to be adjacent to the optical portion 112. As a specific example, the flange portion 114 may have a constant size along the edge of the optical portion 112. The flange portion 114 may not have refractive power. For example, the first surface and the second surface of the flange portion 114 may be flat so that incident light is not refracted. For another example, the flange portion 114 may be coated with a light-blocking material so that light does not pass therethrough. For another example, the flange portion 114 may be processed or surface-treated to a significant roughness so that light does not pass therethrough.

The second optical member 120 may be made of a material different from that of the first optical member 110. For example, the second optical member 120 may be made of a material, such as synthetic resin or plastic that is easy to process. However, the material of the second optical member 120 is not limited to the materials mentioned above. The second optical member 120 may be disposed on at least one surface of the first optical member 110. The second optical member 120 may be disposed directly on the first surface of the first optical member 110. For example, the second optical member 120 in an uncured state may be cured or molded into a certain shape through the first optical member 110 and a molding mold. The second optical member 120 configured in this manner may be disposed in close contact with the first surface of the first optical member 110.

The second optical member 120 may be configured to have both a spherical surface and an aspherical surface. For example, the first surface of the second optical member 120 contacting the first optical member 110 may have a spherical surface, and the second surface not contacting the first optical member 110 may have an aspherical surface.

The third optical member 140 may be made of a different material from that of the first optical member 110. For example, the third optical member 140 may be made of a material, such as synthetic resin or plastic that is easy to process. For another example, the third optical member 140 may be made of a material the same as or similar to that of the second optical member 120. The third optical member 140 may be disposed on at least one surface of the first optical member 110. The third optical member 140 may be disposed directly on the second surface of the first optical member 110. For example, the third optical member 140 in an uncured state may be cured or molded into a certain shape through the first optical member 110 and a molding mold. The third optical member 140 configured in this manner may be disposed in close contact with the second surface of the first optical member 110.

The third optical member 140 may be configured to have both a spherical surface and an aspherical surface. For example, the first surface of the third optical member 140 contacting the first optical member 110 may have a spherical surface, and the second surface of the third optical member 140 not contacting the first optical member 110 may have an aspherical surface.

The optical element 102 according to the present embodiment may be configured to improve bonding strength between the first optical member 110 and the second optical member 120 and the third optical member 140. For example, portions of the first optical member 110 contacting the second optical member 120 and the third optical member 140 may be configured to have different roughness.

The optical portion 112 of the first optical member 110 may include first regions 1122a and 1122b and second regions 1124a and 1124b as illustrated in FIG. 4. The first regions 1122a and 1122b and the second regions 1124a and 1124b may be configured to have a different roughness. For example, the first regions 1122a and 1122b may be configured to have roughness less than that of the second regions 1124a and 1124b. As an example, the first regions 1122a and 1122b may have a roughness of a size having almost no effect on the refractive power of light. As a specific example, the first regions 1122a and 1122b may have a roughness ranging from 1.0 nm to 10 nm. As another example, the second regions 1124a and 1124b may have a roughness of a size that may improve bonding strength between the first optical member 110 and the second optical member 120 and the third optical member 140. As a specific example, the second regions 1124a and 1124b may have a roughness ranging from 1.0 µm to 20 µm. As another specific example, the second regions 1124a and 1124b have a roughness ranging from 0.20 µm to 4 µm.

The first regions 1122a and 1122b may be configured to be wider than the second regions 1124a and 1124b. As an example, the second regions 1124a and 1124b may be configured to be limited to the edges of the first regions 1122a and 1122b. As another example, the second regions 1124a and 1124b may be configured to have a predetermined interval along the edge of the first regions 1122a and 1122b.

The optical element 102 according to the present embodiment may further include a component capable of improving optical performance. For example, the optical element 102 may further include coating members 130 and 150. The first coating member 130 may be disposed between the first optical member 110 and the second optical member 120, and the second coating member 150 may be disposed between the first optical member 110 and the third optical member 140. For example, the coating members 130 and 150 may be disposed only in a region corresponding to the first regions 1124a and 1124b of the first optical member 110. The coating members 130 and 150 may be made of an inorganic material, such as TiO₂, SiO₂, MgF₂, or a composite material including the aforementioned material. The coating members 130 and 150 configured in this manner may form an anti-reflective layer on the optical element 102 to suppress a flare phenomenon that may occur between the first optical member 110 and the second optical member 120 and between the first optical member 110 and the third optical member 140.

Since the optical element 102 configured as described above has aspherical surfaces disposed on both sides of the optical portion 112, the optical characteristics of the optical element 102 may be further improved.

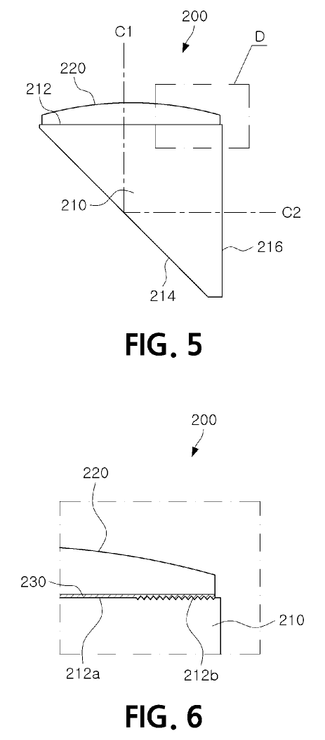

Next, an optical element according to a third embodiment will be described with reference to FIGS. 5 and FIG. 6.

An optical element 200 according to the present embodiment may include two or more different materials. As an example, the optical element 200 may include a first optical member 210 and a second optical member 220. However, the configuration of the optical element 200 is not limited to the first optical member 210 and the second optical member 220. For example, the optical element 200 may further include a third optical member, different from the first optical member 210 and the second optical member 220.

The first optical member 210 may be configured in a form including an incident surface 212, a reflective surface 214, and an exit surface 216. For example, the first optical member 210 may be configured in the form of a prism. The optical element 200, for example, the first optical member 210, may bend (refract, reflect) incident light along a first optical axis C1 to a second optical axis C2. The first optical member 210 may be made of a material having excellent optical transparency and high rigidity. For example, the first optical member 210 may be made of glass.

The second optical member 220 may be configured to have refractive power. For example, the second optical member 220 may have positive or negative refractive power. The second optical member 220 may be made of a material different from that of the first optical member 210. For example, the second optical member 220 may be made of a material, such as synthetic resin or plastic that is easy to process. However, the material of the second optical member 220 is not limited to the aforementioned materials. The second optical member 220 may be disposed on at least one surface (the incident surface 212 or exit surface 216) of the first optical member 210. The second optical member 220 may be disposed directly on one surface of the first optical member 210. For example, the second optical member 220 in an uncured state may be cured or molded into a certain shape through the first optical member 210 and a molding mold. The second optical member 220 configured in this manner may be disposed in close contact with one surface of the first optical member 210.

The second optical member 220 may be configured to include an aspherical surface. For example, the first surface of the second optical member 220 contacting the first optical member 210 may have a flat surface, and the second surface not contacting the first optical member 210 may have an aspherical surface.

The optical element 200 according to the present embodiment may be configured to improve bonding strength between the first optical member 210 and the second optical member 220. For example, a portion of the first optical member 210 contacting the second optical member 220 may be configured to have different roughness.

The incident surface 212 of the first optical member 210 may include a first region 212a and a second region 212b as illustrated in FIG. 6. The first region 212a is disposed around a first optical axis C1 of the incident surface 212, and the second region 212b may be disposed at the edge of the first region 212a.

The first region 212a and the second region 212b may be configured to have different roughness. For example, the first region 212a may be configured to have a roughness less than that of the second region 212b. As an example, the first region 212a may have a roughness of a size having almost no effect on refractive power of light. As a specific example, the first region 212a may have a roughness ranging from 1.0 nm to 10 nm. As another example, the second region 212b may have a roughness of a size that may improve bonding strength between the first optical member 210 and the second optical member 220. As a specific example, the second region 212b may have a roughness ranging from 1.0 µm to 20 µm. As another specific example, the second region 212b may have a roughness ranging from 0.20 µm to 4 µm.

The first region 212a may be formed to be wider than the second region 212b. As an example, the second region 212b may be configured to be limited to the edge of the first region 212a. As another example, the second region 212b may be disposed along the edge of the first region 212a at a predetermined interval.

The optical element 200 according to the present embodiment may further include a component capable of improving optical performance. For example, the optical element 200 may further include a coating member 230. The coating member 230 may be disposed between the first optical member 210 and the second optical member 220. For example, the coating member 230 may be disposed only in a region corresponding to the first region 212a of the first optical member 210. The coating member 230 may be made of an inorganic material, such as TiO₂, SiO₂, or MgF₂, or may be made of a composite material including the aforementioned material. The coating member 230 configured in this manner may form an anti-reflective layer on the optical element 200 to suppress a flare phenomenon that may occur between the first optical member 210 and the second optical member 220.

Since the optical element 200 configured as described above includes both the characteristics of a prism having a reflective surface and the characteristics of a lens having refractive power, the optical element 200 may be advantageous for miniaturization and thinning of a camera module.

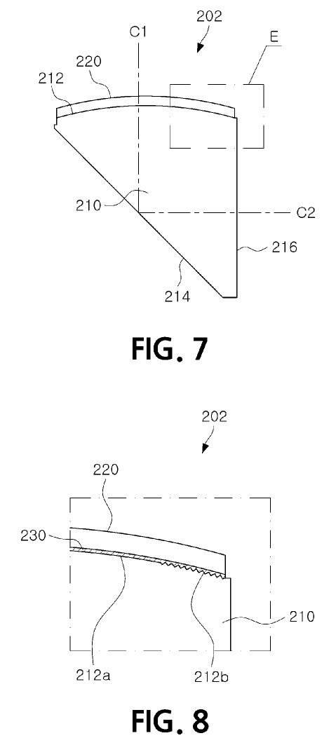

Next, an optical element according to a fourth embodiment will be described with reference to FIGS. 7 and 8.

An optical element 202 according to the present embodiment may include two or more different materials. For example, the optical element 202 may include a first optical member 210 and a second optical member 220. However, the components of the optical element 202 are not limited to the first optical member 210 and the second optical member 220. For example, the optical element 202 may further include a third optical member, different from the first optical member 210 and the second optical member 220.

The first optical member 210 may be configured in a form including an incident surface 212, a reflective surface 214, and an exit surface 216. For example, the first optical member 210 may be configured in the form of a prism. The reflective surface 214 may reflect light incident along the first optical axis C1 to emit light along the second optical axis C2. The first optical member 210 may be made of a material having excellent optical transparency and high rigidity. For example, the first optical member 210 may be made of a glass material.

The first optical member 210 may be configured to have refractive power. For example, the first optical member 210 may have positive or negative refractive power. To this end, the incident surface 212 or the exit surface 216 of the first optical member 210 may have a convex or concave shape. As an example, the incident surface 212 of the first optical member 210 may be convex or concave and the exit surface 216 may be flat. As another example, the incident surface 212 of the first optical member 210 may be flat and the exit surface 216 may be convex or concave. As another example, the incident surface 212 of the first optical member 210 may be convex or concave, and the exit surface 216 may be convex or concave.

The first optical member 210 may be configured in a shape including a sphere. For example, the incident surface 212 and the exit surface 216 having a convex or concave shape according to the embodiment described above may both have a spherical shape having a constant radius of curvature.

The second optical member 220 may be made of a material different from that of the first optical member 210. For example, the second optical member 220 may be made of a material, such as synthetic resin or plastic that is easy to process. However, the material of the second optical member 220 is not limited to the materials described above. The second optical member 220 may be disposed on at least one surface (incident surface 212 or exit surface 216) of the first optical member 210. The second optical member 220 may be disposed directly on one surface of the first optical member 210. For example, the second optical member 220 in an uncured state may be cured or molded into a certain shape via the first optical member 210 and a molding mold. The second optical member 220 configured in this manner may be disposed in close contact with one surface of the first optical member 210.

The second optical member 220 may be configured in a shape including an aspherical surface. For example, the first surface of the second optical member 220 contacting the first optical member 210 may have a flat or spherical surface, and the second surface of the second optical member 220 not contacting the first optical member 210 may have an aspherical surface. As a more specific example, the first surface of the second optical member 220 contacting the first optical member 210 may have a radius of curvature the same as or similar to that the first optical member 210.

The optical element 202 according to the present embodiment may be configured to improve bonding strength between the first optical member 210 and the second optical member 220. For example, a portion of the first optical member 210 contacting the second optical member 220 may be configured to have different roughness.

The incident surface 212 of the first optical member 210 may include a first region 212a and a second region 212b as illustrated in FIG. 8. The incident surface 212 of the first optical member 210 may include a first region 212a and a second region 212b as illustrated in FIG. 6. The first region 212a may be disposed around the first optical axis C1 of the incident surface 212, and the second region 212b may be disposed at the edge of the first region 212a.

The first region 212a and the second region 212b may be configured to have different roughness. For example, the first region 212a may be configured to have a roughness less than the second region 212b. For example, the first region 212a may have a roughness of a size having almost no effect on the refractive power of light. Specifically, the first region 212a may have a roughness ranging from 1.0 nm to 10 nm. As another example, the second region 212b may have a roughness of a size capable of improving bonding strength between the first optical member 210 and the second optical member 220. Specifically, the second region 212b may have a roughness ranging from 1.0 µm to 20 µm. As another specific example, the second region 212b may have a roughness ranging from 0.20 µm to 4 µm.

The first region 212a may be configured to be wider than the second region 212b. For example, the second region 212b may be configured to be limited to the edge of the first region 212a. As another example, the second region 212b may be disposed along the edge of the first region 212a at a predetermined interval.

The optical element 202 according to the present embodiment may further include a component capable of improving optical performance. For example, the optical element 202 may further include a coating member 230. The coating member 230 may be disposed between the first optical member 210 and the second optical member 220. For example, the coating member 230 may be disposed only in a region corresponding to the first region 212a of the first optical member 210. The coating member 230 may be made of an inorganic material, such as TiO₂, SiO₂, or MgF₂, or may be made of a composite material including the aforementioned materials. The coating member 230 configured in this manner may form an anti-reflective layer on the optical element 202 to suppress a flare phenomenon that may occur between the first optical member 210 and the second optical member 220.

Since the optical element 202 configured as described above includes an aspherical surface, the optical element 202 may be advantageous for improving aberration of an optical element including a reflective surface.

The present disclosure may provide the optical element having optical properties of glass material, while being easy to implement an aspherical shape.

In addition, the optical element according to the present disclosure may be manufactured easily and may be produced at low cost.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical element comprising:
a first optical member having refractive power and made of a glass material;
a second optical member disposed on a first surface of the first optical member and made of a plastic material; and
a first coating member disposed between the first optical member and the second optical member,
wherein the first surface includes a first region having a first roughness and a second region having a second roughness.

2. The optical element of claim 1, wherein the first surface has a spherical shape.

3. The optical element of claim 1, wherein the second optical member includes an aspherical shape.

4. The optical element of claim 1, wherein the first region is disposed around an optical axis of the first surface, and the second region is disposed at an edge of the first region.

5. The optical element of claim 4, wherein the first roughness is less than the second roughness.

6. The optical element of claim 1, wherein the first surface has a convex or concave shape.

7. The optical element of claim 1, further comprising a third optical member disposed on a second surface of the first optical member.

8. An optical element comprising:
a first optical member including an incident surface, a reflective surface, and an exit surface and made of a glass material;
a second optical member disposed on a first surface of the first optical member and made of a plastic material; and
a first coating member disposed between the first optical member and the second optical member,
wherein the first surface includes a first region having a first roughness and a second region having a second roughness.

9. The optical element of claim 8, wherein the first region is disposed around an optical axis of the first surface, and the second region is disposed at an edge of the first region.

10. The optical element of claim 8, wherein the second optical member has a shape including an aspherical surface.

11. The optical element of claim 8, wherein the second optical member has a shape having refractive power.

12. The optical element of claim 8, wherein the first optical member has a shape having refractive power.

13. The optical element of claim 12, wherein one or more of the incident surface and the exit surface has a convex or concave shape.

14. The optical element of claim 12, wherein one or more of the incident surface and the exit surface has a spherical shape.

15. The optical element of claim 12, wherein the second optical member has an aspherical shape.
